(19) United States
(12) Patent Application Publication
(10) Pub. No.: US 2010/0325266 A1
(43) Pub. Date: Dec. 23, 2010

(54) WEB SERVICE PROCESSING METHOD FOR A WEB SERVER PROVIDING DEVICE, AND A WEB SERVICE PROVIDING DEVICE

(75) Inventors: Nobuhiko Nishimura, Ueda-shi (JP); Toshihiro Hagiwara, Ueda-shi (JP); Atsushi Sakai, Sakaki-machi (JP); Yuichi Ito, Ueda-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/818,124

(22) Filed: Jun. 17, 2010

(30) Foreign Application Priority Data
Jun. 23, 2009 (JP) 2009-148299

(51) Int. Cl. G06F 15/173

(52) U.S. Cl. 709/224

(57) ABSTRACT

A web service processing method for a web server providing device, and a web service providing device enable eliminating the process delay that occurs the first time a web service is accessed. A web service provider 1 has a services table 26 storing a list of web services 24 that can be provided, and provides web services 24 to users. The web service provider 1 monitors if the web services 24 stored in the services table 26 are in a usable state, and if as a result of this monitoring determines that a web service 24 is not usable, asserts an initialization process request to the web service 24 to initialize the web service 24 for use.

This application claims priority under 35 U.S.C. §119 to Japanese Patent Application No. 2009-148299 filed on Jun. 23, 2009, the entire disclosure of which is expressly incorporated by reference herein.

### BACKGROUND

1. Technical Field

The present invention relates to a web service processing method for a web service providing device that provides a web service to a client device (user), to a method of calling a web service, and to a web service providing device.

2. Related Art

A web service providing device (“web service provider”) that uses SOAP (Simple Object Access Protocol) to send and receive data in an XML (eXtensible Markup Language) format to provide a service (a web service) that enables client devices (users) to receive specific functions or information over the World Wide Web (referred to herein as simply “web”) is taught in Japanese Unexamined Patent Appl. Pub. JP-A-2004-151942, for example. When the web service provider receives information from a client device (a user-side device) requesting a web service, the web service provider provides from among all of the web services that are available from the web service provider a list of web services that can be used by the client device. The client device then selects the service to be used from the list, and can use the desired web service by calling (accessing) that service.

When a client device uses a web service, however, the web service provider loads and initializes the requested web service the first time that service is called after the web service provider starts up, enabling the web service to be used. However, this initialization process may be time-consuming. As a result, the first time the client device accesses the web service, the client device may need to wait some time until the requested web service can be used. In other words, a process delay (delay time) is caused by the initialization process.

### SUMMARY

A web service processing method for a web service providing device, and a web service providing device according to at least one of embodiment of the present invention can eliminate a processing delay the first time a web service is accessed.

A first aspect of the invention is a web service processing method for a web service providing device that has a storage unit storing a list of provideable web services and provides the web services to one or more connected client devices, wherein the web service providing device executes: a monitoring step of monitoring if a web service stored in the storage unit can be used; and an initialization process request step that, when the monitoring step determines that the web service is not usable, asserts an initialization process request to the web service to initialize the web service for use.

Another aspect of the invention is a web service calling program recording media for calling web services, the web service calling program operating on a web service providing device that has a storage unit storing a list of provideable web services and provides the web services to one or more connected client devices, and including: a monitoring unit that monitors if a web service stored in the storage unit can be used; and an initialization process request unit that, when the monitoring unit determines that the web service is not usable, asserts an initialization process request to the web service to initialize the web service for use.

Another aspect of the invention is a web service providing device that provides a web service to one or more connected client devices, the web service providing device including a storage unit that stores a list of web services that can be provided; a monitoring unit that monitors whether or not the web services stored in the storage unit can be used; and an initialization process request unit that, when the monitoring unit determines that the web service is not usable, asserts an initialization process request to the web service to initialize the web service for use.

These aspects of the invention monitor the status of particular web services, and, if as a result of this monitoring determine that a web service is not in a usable state, assert an initialization process request to that web service to initialize the web service for use. As a result, any particular web service can be constantly held in the state resulting from completion of the initialization process (that is, the web service can be constantly held in a usable state). At least one of embodiment of the invention can therefore provide an environment in which web services can be used immediately when a web service is accessed (when the web service is used) without causing the client device (user) to wait even if it is the first time the client device accesses the requested web service. More specifically, the prior art problem of a process delay (waiting time) being caused by the web service initialization process can be solved.

In the web service processing method of a web service providing device described above, the monitoring step preferably determines if the web service can be used by monitoring the status of a web service container that is the web service execution environment. At least one of embodiment of the invention can thus provide, for example, an environment in which web services can be quickly used in conjunction with the startup of the operating system (OS) of the web service providing device.

In the web service calling program on the recording media described above, the initialization process request unit preferably asserts an initialization process request to the web service linked to the startup of the web service providing device.

In the web service providing device described above, the initialization process request unit preferably asserts an initialization process request for the web service linked to startup of the web service providing device.

Further preferably in the web service providing device described above, the web service causes a connected printer to print print data received from a client device, and sends the result of the printing process to the client device.

These aspects of the invention execute the web service initialization process in conjunction with the startup of the web service providing device (more specifically, the operating system (OS) booting up), that is, triggered by the startup of the web service providing device. As a result, the web services can be reliably initialized and enabled for use before a connected client device accesses a web service. An environment in which a desired web service can be used quickly without causing the user to wait even when a web service is accessed for the first time can therefore be provided.

Further preferably in the web service processing method of a web service providing device according to another aspect of the invention, the monitoring step determines if the web service can be used by monitoring the status of a web service container that manages the web services.

In the web service processing method of a web service providing device according to another aspect of the invention, the monitoring step determines if the web service can be used by monitoring if the web service is loaded in a specific memory.

In the web service processing method of a web service providing device according to another aspect of the invention, the web service providing device is connected to one or more devices corresponding to the web services stored in the storage unit; and the monitoring step determines if the web service can be used by monitoring if the corresponding device can be used.

In a web service calling program on the recording media according to another aspect of the invention, the web service providing device is connected to one or more devices corresponding to the web services stored in the storage unit; and the monitoring unit determines whether or not the web services can be used by monitoring one or more of the state of a web service container that manages the web services, whether or not the web service is loaded in a specific memory, and whether or not the corresponding device is operable.

In a web service providing device according to another aspect of the invention, the web service providing device is connected to one or more devices corresponding to the web services stored in the storage unit; and the monitoring unit determines whether or not the web services can be used by monitoring one or more of the state of a web service container that manages the web services, whether or not the web service is loaded in a specific memory, and whether or not the corresponding device can be used.

With these aspects of the invention whether or not web services can be used can be accurately and efficiently determined based on the result of monitoring the state of the web services container, whether or not web services are loaded in memory, and whether or not the corresponding devices can be operated.

Further preferably in a web service processing method for a web service providing device according to another aspect of the invention, the list of web services stored in the storage unit is separated into web services that are to be monitored and web services that are not monitored; and of the web services stored in the storage unit, the monitoring step monitors only the web services that are to be monitored.

Further preferably in a web service processing method for a web service providing device according to another aspect of the invention, of the web services stored in the storage unit, the monitoring step monitors only web services written in a specific language.

Further preferably in a web service processing method for a web service providing device according to another aspect of the invention, of the web services stored in the storage unit, the initialization process request step asserts an initialization process request for a web service that is not monitored by the monitoring step when a process request is received from the client device.

Because all web services stored in the storage unit do not necessarily need to be constantly initialized and ready for use, these aspects of the invention monitor only those web services that must be constantly enabled for use, and can therefore eliminate processes that are not immediately necessary (processes including monitoring and initialization process requests). As a method of accomplishing this, whether or not a web service requires monitoring can be easily and accurately determined by previously separating the list of web services stored in the storage unit into web services that are monitored and web services that are not monitored. Yet further, the need to categorize the web services can be omitted by, for example, monitoring only those web services that are written in a specific language. In addition, use of web services that are not monitored is not inhibited because an initialization process request is asserted when a process request is received from a client device.

Yet further preferably in a web service processing method for a web service providing device according to another aspect of the invention, the storage unit stores for each web service a link to a client device that can use the web service selected from among the one or more client devices; and the monitoring step monitors the startup of each client device, and monitors whether or not the web service linked to a particular (any) client device can be used when startup of that particular client device is detected.

Because a relationship between each web service and the client devices that can use each web service is stored, this aspect of the invention can render only those web services that are used by a particular client device usable when that particular client device starts up. As a result, unnecessary processes, such as initializing a web service that is used only by a particular client device even though that client device has not started operating, can be eliminated.

Yet further preferably in a web service processing method for a web service providing device according to another aspect of the invention, the storage unit stores a priority level for each web service, and the monitoring step monitors the usability of web services linked to a desired client device according to the priority level of each web service.

By thus assigning a priority level according to the importance of the web services used by the client device (by setting a high priority level for web services that are desirably quickly rendered usable), this aspect of the invention can further reduce the operating delay of the client device.

Further preferably in a web service providing device according to another aspect of the invention, the web service receives a command from the client device, asserts a process request to a connected device based on said command, and sends the process result to the client device.

Further preferably in a web service providing device according to another aspect of the invention, the client device is a POS terminal, and the web service is a software module for controlling a peripheral device of the POS terminal.

These aspects of the invention can provide, for example, a service that receives data for printing a receipt from a POS terminal, causes a receipt printer connected to the web service providing device to execute a printing process using the receipt printing data, and reports the result of the printing process (success or failure) to the POS terminal. This configuration can improve work efficiency because the POS terminal, which is a client device, can quickly issue a receipt without waiting for the initialization process.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram of a web service providing system according to a preferred embodiment of the invention.

FIG. 2 is a block diagram of a web service providing device (web service provider).

FIG. 3 shows an example of a table listing available web services in the first embodiment of the invention.

FIG. 4 is a flow chart of the web service initialization process.

FIG. 5 shows another example of a table listing available web services in the first embodiment of the invention.

FIG. 6 shows an example of a table listing available web services in a second embodiment of the invention.

FIG. 7A shows an example of a web service prioritization table for a POS system.

FIG. 7B shows an example of prioritization table for a management server.

### DESCRIPTION OF EMBODIMENTS

Preferred embodiments of a web service processing method for a web service providing device, and a web service providing device according to at least one of embodiment of the present invention are described below with reference to the accompanying figures. This embodiment of the invention describes a web service providing system that provides a web service by means of a web service providing device (web service provider) based on a web service usage request from a user (client device).

### Embodiment 1

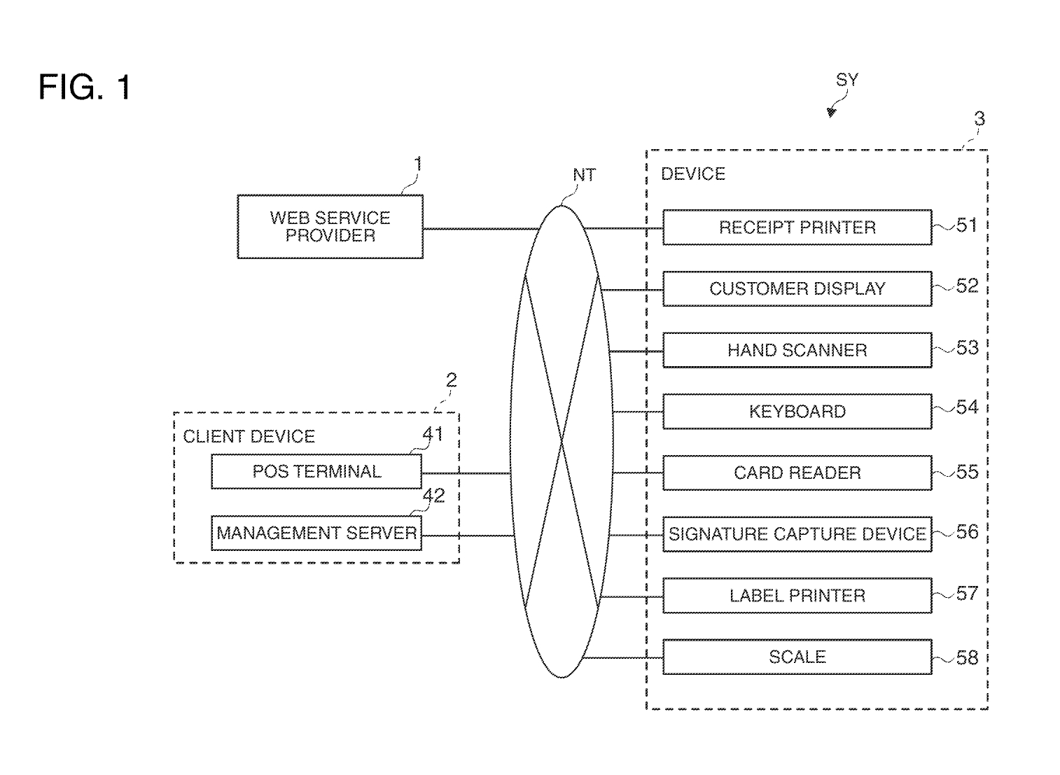

FIG. 1 is a block diagram of a web service providing system SY according to this embodiment of the invention. As shown in the figure, the web service providing system SY includes a web service provider 1 that provides one or more web services 24, at least one client device 2 that accesses the web service provider 1, and a device 3 that is controlled by one or more web services 24. The web service provider 1 and client device 2 are connected over the Internet or other network NT. Note that the connection between the web service provider 1 and the client device 2 is not limited to an Internet connection, and may be a wired or wireless LAN connection, for example.

The client device 2 is a device enabling the user to use a web service 24. The web service providing system SY according to this embodiment of the invention has a POS terminal 41 and a management server 42 as client devices 2.

The POS terminal 41 is installed at the checkout counter of a store, and processes customer transactions. The management server 42 is installed in the store's back office, for example, stores a database (product master) for managing product name, code, price, inventory, and other types of information, supplies information to the POS terminal 41, and is used to produce product labels that are affixed to the products.

The user uses a web browser (not shown in the figure) installed on the client device 2, and uses a desired web service 24 by asserting a process request (also referred to below as “service process requests”) for using a web service 24 to the web service provider 1, and receiving process results returned from the web service provider 1 in response to the process request.

The device 3 is an electronic device that is controlled by a web service 24. The web service providing system SY according to this embodiment of the invention includes as devices 3 a receipt printer 51 for issuing receipts, a customer display 52 for displaying transaction information to a customer, a hand scanner 53 for reading product label barcodes, a keyboard 54 for inputting product codes and operating commands, a card reader 55 for reading cards such as membership cards and credit cards, a signature capture device 56 for signature recognition, a label printer 57 for producing product labels, and a scale 58 for weighing products to print weight and price information on the product labels. Of these, the receipt printer 51, customer display 52, hand scanner 53, keyboard 54, card reader 55, and signature capture device 56 are used by the POS terminal 41, that is, function as POS peripherals. The label printer 57 and scale 58 are used by the management server 42. The web service provider 1 is thus connected to a plurality of client devices 2 and a plurality of devices 3, and can use each of the devices 3 by providing web services 24 appropriate to each device 3 to each of the client devices 2.

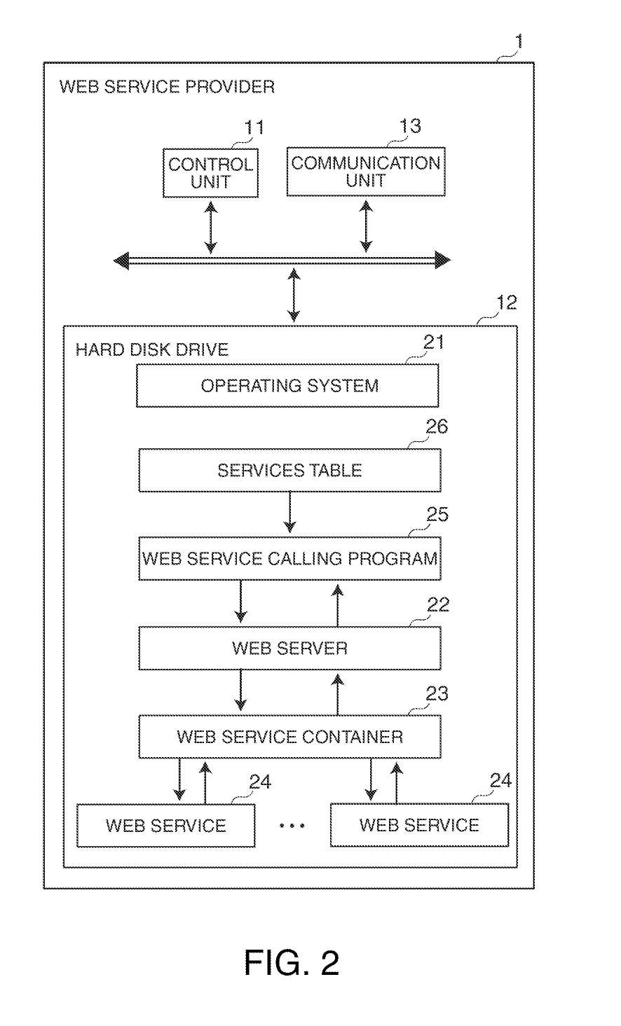

FIG. 2 is a block diagram of the web service provider 1. The web service provider 1 is a device that provides specific web services 24 to the client device 2, and in addition to a control unit 11, hard disk drive 12, and communication unit 13, has other hardware components typically included in a common personal computer. The communication unit 13 is an interface for communicating with the client devices 2.

The main components of the control unit 11 are a CPU (central processing unit), ROM (read-only memory), and RAM (random access memory). The CPU runs a program stored in ROM or the hard disk drive 12, for example, and controls overall operation of the web service provider 1. ROM is nonvolatile memory, and stores a basic computer control program (boot program, BIOS, or other program) and control data. RAM is volatile memory, and is used as working memory for temporarily storing data and programs loaded from ROM or the hard disk drive 12, for example, and when the CPU executes various processes.

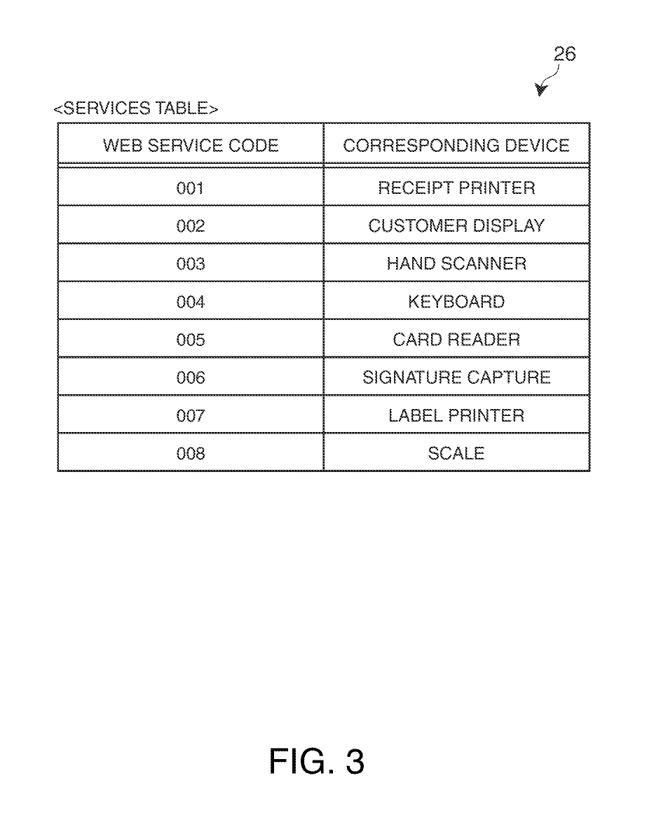

The hard disk drive 12 stores the operating system 21, a web server 22, a web service container 23, the web services 24, and a web service calling program 25. The hard disk drive 12 also stores a services table 26 (storage unit). A list of the web services 24 that can be provided to the users is stored in this services table 26. As shown in FIG. 3, the services table 26 stores web service codes for identifying each of the web services 24 linked to the corresponding device. Note that the web services 24 and corresponding devices 3 are in a 1:1 relationship in the table shown in FIG. 3, but these may be in an N:1 or a 1:N relationship (where N is an integer ≧2).

The web server 22 is a service (software module) that has a function for receiving a service process request from a client device 2 to use a particular web service 24, and returning the result of processing the request to the client device 2. Processing these service process requests is handled through the web service container 23. More specifically, when a service process request is received from a client device 2, the web server 22 asks the web service container 23 to execute a service based on the received service request (that is, to execute the corresponding web service 24). The web server 22 then receives from the web service container 23 a report indicating that execution of the requested service process has been completed and the result thereof, and sends the result to the client device 2.

For example, the web server 22 has a web service 24 for receiving receipt print data from a POS terminal 41, causing a receipt printer 51 connected to the network NT to execute the printing process, and sending the result of the printing process to the POS terminal 41. This enables quickly issuing a receipt to the customer.

The web server 22 receives an initialization process request for a web service 24 from a web service calling program 25 described below. This initialization process request is a request to enable a particular web service 24 for use, that is, to initialize the web service 24, and the web server 22 requests the web service container 23 to execute the initialization process of the web service 24 based on the received initialization process request. The web server 22 then receives the result of processing the initialization process request (that is, a success/failure report) from the web service container 23, and passes the result to the web service calling program 25. Note that initialization process requests from the web server 22 to the web service container 23 are executed after the web server 22 activates the web server 22 (loads it into memory (RAM)).

The web service container 23 is a service (software module) that functions as an environment for executing a web service 24. The web service container 23 intercedes between the web server 22 and a web service 24, and asks the web service 24 to execute a particular process based on the content of the received request when a service process request is received from the web server 22. When the web service 24 process ends, a completion report is returned to the web server 22.

When the web service container 23 receives an initialization process request for a web service 24 from the web server 22, the web service container 23 requests execution of the initialization process for that web service 24. When initializing the web service 24 is completed, the web service container 23 returns a response indicating completion and the result to the web server 22. Note that web service 24 initialization process requests from the web service container 23 are executed after the web service container 23 loads the web service 24 into memory (RAM).

A web service 24 is a software module for providing a particular process or information to a client device 2 (user-side device) using SOAP (a protocol for sending and receiving data in an XML format). For example, a web service 24 may provide a service for executing a process based on a process request from a client device 2, and returning the result of the process. Note that in addition to services related to POS processes and product label production processes as described above, these web services 24 are also applicable to services for searching and sending particular information.

A web service 24 executes processes based on process requests for services, for example, from the web service container 23 (from a client device 2). When a process ends, the web service 24 returns a response indicating process completion and the process result to the web service container 23. The web service 24 has a function (such as a dedicated calculation function) for receiving an initialization process request from the web service container 23 (from the web service calling program 25), and executes its own initialization process based on this initialization process request.

The web service calling program 25 is a program for executing the initialization processes of web services 24 registered in the services table 26, and is automatically invoked (executed) in conjunction with activation of the web service provider 1 (in conjunction with the operating system 21 starting up). The web service calling program 25 has an active mode and a monitoring mode, and enters the active mode immediately after startup. In the active mode the web service calling program 25 asserts an initialization process request to all of the web services 24 registered in the services table 26 through the web server 22 and the web service container 23. This initialization process request is executed repeatedly until the initialization processes of the web services 24 succeed, and the web service calling program 25 enters the monitoring mode after the initialization process succeeds.

In the monitoring mode, the web service calling program 25 functions as a monitoring unit that monitors the status of all web services 24 registered in the services table 26 at a specific interval, that is, regularly. More specifically, the web service calling program 25 determines whether or not a web service 24 can be used, that is, whether the initialization process is needed. If a web service 24 cannot be used (that is, execution of the initialization process for that web service 24 is determined necessary), the web service calling program 25 moves to the active mode and executes the initialization process for that web service 24. Note that whether or not a web service 24 can be used can be determined in the monitoring mode by checking the status of the web service container 23 and whether or not the web service 24 is loaded in RAM.

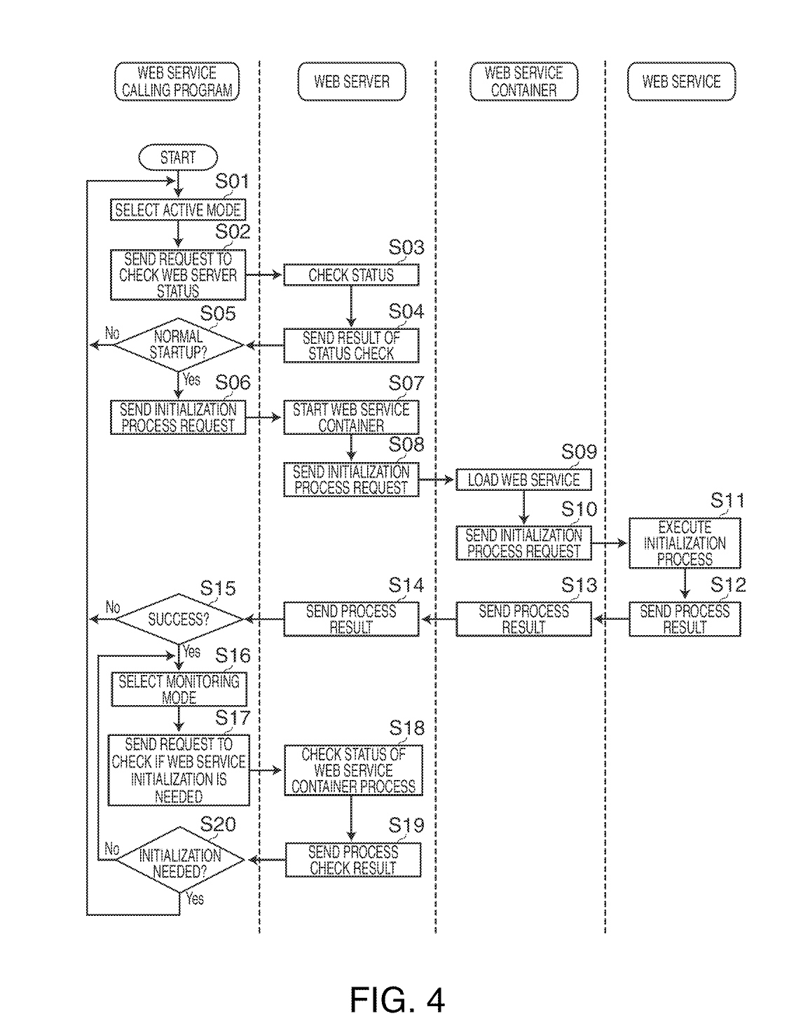

The web service 24 initialization process (web service initialization process method) executed by the web service calling program 25 is described next with reference to the flow chart in FIG. 4. Note that the process described below is achieved by the control unit 11 (CPU) controlling execution of particular programs (the web server 22, web service container 23, web service 24, and web service calling program 25).

When the web service provider 1 (operating system 21) starts up, the web service calling program 25 is started and enters the active mode (S01). At this time the web service calling program 25 sends a query to the web server 22 to check if the web server 22 is operating normally (a request to check if the web server 22 is in the normal operating state) (S02). When the web server 22 receives this query from the web service calling program 25, it checks its own status (S03) and returns a response determined by this status (S04).

The web service calling program 25 then determines if the web server 22 was activated normally based on the content of the response from the web server 22. If the content of the response from the web server 22 indicates that it is not operating normally (an error is returned) or if a response from the web server 22 is not received within a specified time (S05 returns No), the web service calling program 25 determines the web server 22 did not start up normally and repeats the process from step S01. If this sequence of steps repeats a specific number of times and the web server 22 has still not started normally, the web service calling program 25 may determine an error has occurred and stop repeating the process.

If the response from the web server 22 indicates normal operation (S05 returns Yes), the web service calling program 25 references the services table 26 and sends an initialization process request to the web server 22 to initialize all web services 24 registered in the services table 26 (S06, initialization process request step, initialization process request unit).

The web server 22 then starts (loads) the web service container 23 when the initialization process request is received from the web service calling program 25 (S07). After the web service container 23 starts, the web server 22 sends an initialization process request for the web services 24 to the web service container 23 (S08).

When the web service container 23 receives the initialization process request from the web server 22, it loads the web services 24 to be initialized (reads the web services 24 to be initialized, S09). After the web service 24 loads, the web service container 23 sends an initialization process request to the web service 24 (S10).

The web service 24 then receives the initialization process request from the web service container 23, and executes its own initialization process based on the request (S11). Next, the web service 24 sends the result of the initialization process (execution result) through the web service container 23 and web server 22 to the web service calling program 25 (S12, S13, S14).

The web service calling program 25 receives the initialization process result from the web service 24, and based on this process result determines if the initialization process succeeded or not. If the received initialization process result indicates a “process failure,” or if the process result is not returned within a specific time (S15 returns No), the web service calling program 25 determines that the initialization process of the particular web service 24 failed and repeats operation from S01. If the web service 24 does not operate normally after these steps are executed a specific number of times, the web service calling program 25 may determine that an error occurred and stop repeating the process.

If the received initialization process result indicates a “process success” (S15 returns Yes), the web service calling program 25 moves to the monitoring mode and thereafter checks at a specific timing if the initialization process of a particular web service 24 is needed (determines if a particular web service 24 can be used) (S16, monitoring step, monitoring unit).

The monitoring method used in this embodiment of the invention watches the status of the web service container 23 process, which is the web service 24 execution environment. If this process disappears, the web service 24 initialization process is determined necessary (that is, the web services 24 are determined to be unusable). The process may disappear when, for example, the web service container 23 stops operating (hangs up or freezes) or restarts (reboots). The status of the web services 24 is thus indirectly monitored by monitoring the status of the web service container 23 process. At the same time, the web service calling program 25 monitors whether or not the web services 24 are loaded, and determines that the web service 24 initialization process is necessary if a web service 24 is not loaded.

More specifically, the web service calling program 25 first sends a request to the web server 22 to check whether or not the initialization process of a particular web service 24 is necessary (S17). When this request is received, the web server 22 checks the status of the web service container 23 process, which is the web service 24 execution environment, and if the web service 24 is loaded (S18). The web server 22 then sends the results of these checks to the web service calling program 25 (S19).

The web service calling program 25 receives the result of this check from the web server 22, and based on this result determines if the web service 24 initialization process is required. If the received result indicates that the web service container 23 process is active and the web service 24 is loaded, the web service calling program 25 determines that the initialization process of that web service 24 is not needed (S20 returns No), and repeats operation from step S16.

If the received result indicates that the web service container 23 process does not exist or that the web service 24 is not loaded, the web service calling program 25 determines that the initialization process of that web service 24 is needed (S20 returns Yes), and repeats operation from step S01. Note that if step S20 returns Yes, operation may return to step S06 instead of step S01.

As described above, this embodiment of the invention monitors the state of the selected web service 24 (which is registered in the services table 26), and if the web service 24 is determined to not be usable as a result of this monitoring, requests the web service 24 to execute an initialization process whereby the web service 24 is made usable. As a result, a web service 24 that is to be used can be constantly kept in the state after the initialization process is completed (that is, the web service 24 can be constantly held in a usable state). By doing this, this embodiment of the invention can provide an environment in which when a client device 2 accesses a web service 24 (uses a web service 24), for example, the web service 24 can be used immediately without causing the user (client device 2) to wait even when the web service 24 that is called is accessed for the first time. More specifically, at least one of embodiment of the invention can solve the prior art problem of a process delay that is caused by the initialization process the first time a web service 24 is accessed.

In addition, by executing the web service 24 initialization process in conjunction with the web service provider 1 starting up (the operating system 21 booting), web services 24 can be set to the usable state before any web services 24 are accessed by a user (client device 2).

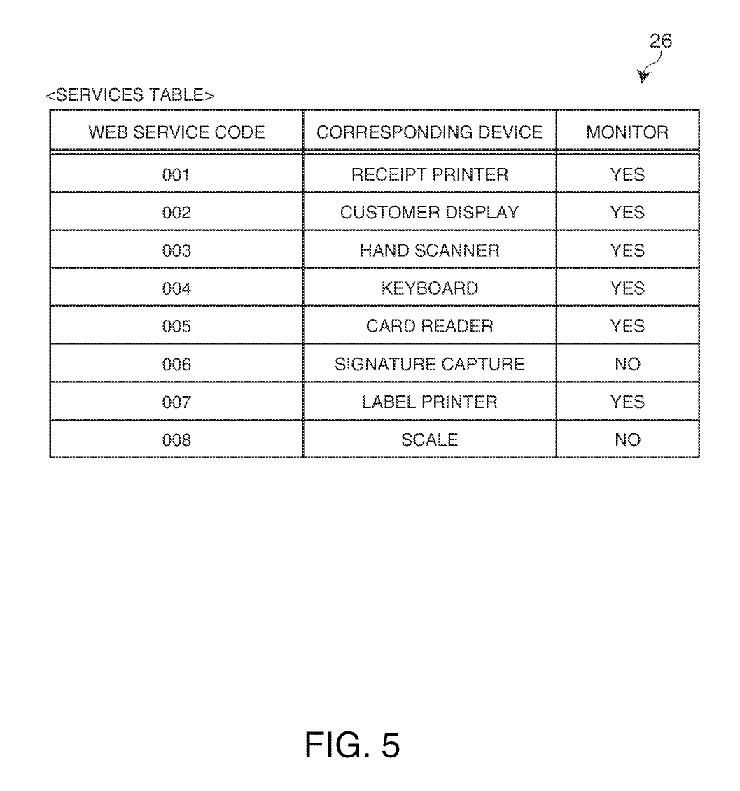

Note that the embodiment described above monitors all web services 24 registered in the services table 26, but may monitor only a part of the web services 24. In this configuration, as shown in FIG. 5, the web services 24 can be stored in the services table 26 with a flag indicating whether a web service is to be monitored or not. More specifically, in the example shown in FIG. 5, the web services 24 identified by web service codes 006 and 008 are not monitored. Note that in this configuration the web service calling program 25 issues an initialization process request when a process request is received from a client device 2 for a web service 24 that is not monitored. Because all web services 24 registered in the services table 26 do not necessarily need to be always usable, these configurations can omit processes that are not needed immediately (processes including monitoring and initialization process requests) by monitoring only those web services 24 that always need to be available for immediate use. Furthermore, by grouping the list of web services 24 registered in the services table 26 into those that are monitored and those that are not monitored, determining whether or not a web service is to be monitored is simple and accurate. In addition, because an initialization process request can be asserted for web services 24 that are not monitored when a process request is received from a client device 2 and immediate processing is not required, there is no interference with using these web services even if some time is required for the initialization process.

Note that whether or not a web service 24 is to be monitored can also be determined from the description language of the web service 24 instead of previously separating the list of web services 24 into those to be monitored and those not to be monitored as shown in FIG. 5. More specifically, of the web services 24 registered in the services table 26, a configuration that monitors only those web services 24 written in a specific language is also conceivable. For example, a configuration that monitors web services 24 written in XML because they require urgency, but does not monitor web services 24 written in another language (such as HTML) because they do not require urgency, is conceivable. With this configuration the task of previously categorizing the web services 24 can be omitted, and when a new web service 24 is added, rewriting the services table 26 is not necessary.

Note, further, that whether or not a web service is monitored may be determined according to other differences such as the program structure, the file structure, or the directory instead of the description language of the web service 24.

Furthermore, in the embodiment described above the web service calling program 25 is started and the web service 24 initialization process is executed in conjunction with the web service provider 1 starting up, but a configuration in which the web service calling program 25 is started and the web service 24 initialization process is executed in conjunction with software other than the operating system 21 starting up, such as the device drive of a particular device 3, is also conceivable. Yet further, a function equivalent to the web service calling program 25 may be incorporated in a web service 24 itself so that when that web service 24 is started the initialization process for another web service 24 is executed (an initialization process request is sent to another web service 24). In this configuration the other web service 24 may be located on the same web service provider 1 or it may be located on different web service provider 1.

The embodiment described above monitors whether or not a web service 24 initialization process is required (whether a web service can be used or not) by monitoring the state of the web service container 23, which is a web service 24 execution environment, or whether a web service 24 is loaded, but the invention is not so limited. For example, a configuration that regularly sends a specific message from the web service calling program 25 to a web service 24 (through the web server 22 and web service container 23), and determines according to the content of the response to this message if the web service 24 initialization process is required, is also conceivable.

Further alternatively, whether or not a web service 24 can be used may be determined by monitoring whether or not the corresponding device 3 can be operated. For example, if the receipt printer 51 is in a non-operating state (such as when the power is off, an error has occurred, or the printer is off-line), the corresponding web service 24 may be determined to be unusable even if the web service container 23 process exists and the corresponding web service 24 is loaded. In addition, if the corresponding device 3 is not usable, an error may be returned to the client device 2 instead of determining that the initialization process is required as in the foregoing embodiment (see S20 in FIG. 4). Further alternatively, the startup of devices 3 connected to the network NT may be monitored and monitoring web services 24 may be started in conjunction with a desired device 3 starting up (a request to check whether or not the web service 24 initialization process is needed may be sent, see S17 in FIG. 4). These configurations enable executing an appropriate process according to the operating state of a corresponding device 3.

### Embodiment 2

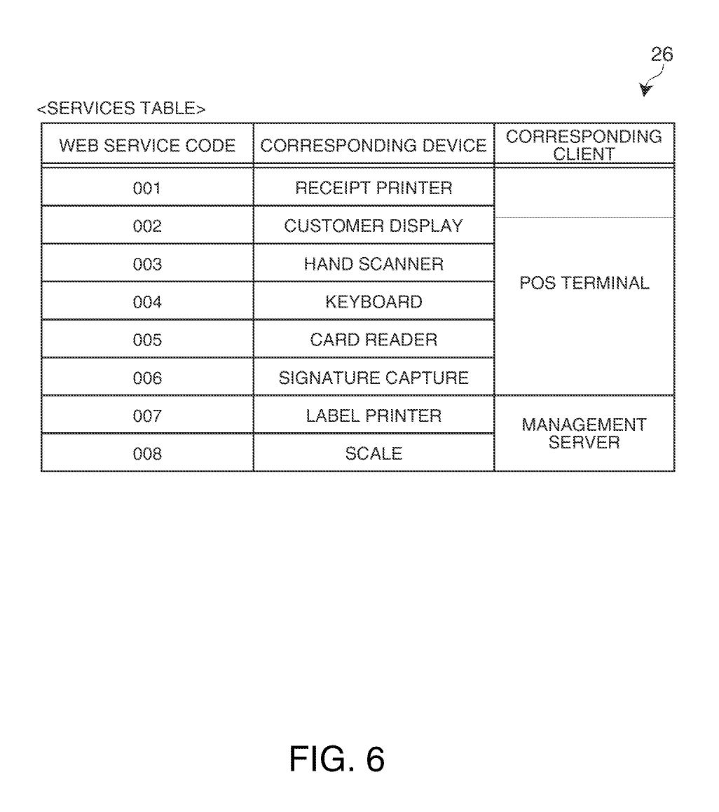

A second embodiment of the invention is described next with reference to FIG. 6. In the foregoing first embodiment, the web service 24 initialization process is executed in conjunction with the web service provider 1 starting up, but this embodiment of the invention differs in that execution of the initialization process is linked to the startup of a client device 2. The differences between this embodiment and the first embodiment are described below. Note that like parts in this and the first embodiment are identified by like reference numerals, and further detailed description thereof is omitted. In addition, variations that are applicable to like parts in the first embodiment are also applicable in this embodiment.

FIG. 6 shows an example of the services table 26 in this second embodiment of the invention. As shown in the figure, the services table 26 in this embodiment stores a link between each web service 24 and the client devices 2 that are connected to the web service provider 1 and can use a particular web service 24. For example, POS terminal 41 is linked as the corresponding client device 2 to the web services 24 (web service codes 001 to 006) corresponding to devices 3 that function as POS peripherals. The web services 24 (web service codes 007 and 008) for a device 3 used to produce product labels are linked to the management server 42 as the corresponding client device 2.

In addition, after entering the monitoring mode (see S16 in FIG. 4), the web service calling program 25 in this embodiment monitors the startup of each client device 2 connected to the network NT. When the startup of any particular client device 2 is detected, the web service calling program 25 references the services table 26 and sends a request to check whether or not the initialization process is required to the web service 24 that is linked to the particular client device 2.

This second embodiment of the invention can thus enable only those web services 24 that can be used by a particular client device 2 linked to the startup of the particular client device 2. As a result, the execution of unnecessary processes, such as requesting the initialization of a web service 24 that is only used by a particular client device 2 even though that client device 2 is not operating, can be eliminated. More specifically, because the web services 24 identified by web service codes to 006 are not used unless the POS terminal 41 has started up in the example shown in FIG. 6, the initialization processes for these web services 24 are not executed when the web service provider 1 has started operating. The control load of the web service provider 1 can therefore be lightened because the monitoring process and initialization request process are executed for the least number of web services 24 required.

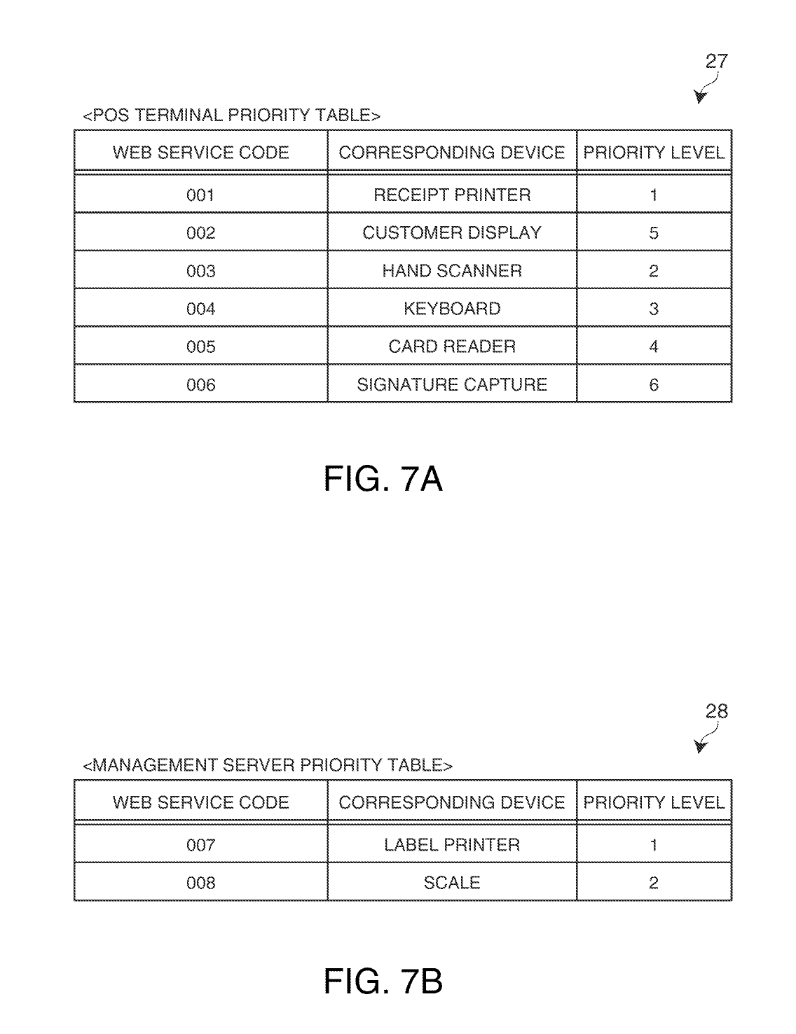

Note that when execution of the web service 24 initialization process is linked to the startup of a client device 2, a priority level is preferably assigned to each web service 24. FIG. 7 shows examples of prioritization tables 27 and 28 in another embodiment of the invention. A prioritization table 27 and 28 is created for each corresponding client device 2. For example, as shown in FIG. 7A, the web service 24 corresponding to the receipt printer 51 has the highest priority for the POS terminal 41. This is because fast processing is needed because a customer waiting for a transaction process to complete will be made to wait longer if much time is needed to issue a receipt. Another reason that the priority level is set high is because if an error (such as a communication error) occurs in the receipt printer 51 or the printer is off-line (such as when there is no paper or the roll paper compartment cover is open), the operator at the check-out counter of a store must be instructed to add roll paper or close the cover.

In addition, because a work delay may result if the web services 24 associated with data input devices such as the hand scanner 53, keyboard 54, and card reader 55 cannot be used, the priority level of these web services 24 are next highest after the receipt printer 51. The priority level of the web service 24 corresponding to the customer display 52 is low because no particular problem results from the display being unusable. The priority level of web services 24 that are rarely used, such as the web service 24 corresponding to the signature capture device 56, is also low. Note, further, that when a drawer kicker (a device for opening the cash drawer), which is another POS peripheral, is connected to the network NT as a device 3, the priority level of the web service 24 corresponding to the drawer kicker may also be set low because it takes time to process payment and make change.

Furthermore, while a detailed description is omitted, priority levels may also be assigned to the web services 24 that are used by the management server 42 as shown in FIG. 7B. By thus assigning priority levels according to the importance of the web service 24 (such as according to the degree of influence a web service 24 has on the operation of the POS terminal 41), the processing delay of the client device 2 can be further reduced.

Note, further, that the web services 24 may also be separated into those that are monitored and those that are not monitored in this embodiment of the invention. More particularly, a priority level is assigned to each of the web services 24, low priority web services (such as the web service 24 corresponding to the signature capture device 56) are not monitored, and the initialization process may be executed for a web service 24 that is not monitored when that web service 24 is requested by a client device 2. For example, when the POS terminal 41 starts up, the initialization process may be executed according to the assigned priority level for each of the web services 24 (web service codes 001 to 005) in FIG. 7A other than the web service 24 corresponding to the signature capture device 56, and the web service 24 corresponding to the signature capture device 56 is initialized when it becomes necessary to recognize a signature.

The invention is not limited to the foregoing embodiments, and a configuration combining the processes of the first embodiment and the second embodiment is also conceivable. Yet further, the configuration of the web service providing system SY, and the hardware configuration and processing steps of the web service provider 1, can also be changed as desired without departing from the scope of the accompanying claims.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A web service processing method for a web service providing device that has a storage unit storing a list of provideable web services and provides the web services to one or more connected client devices, wherein the web service providing device executes:
a monitoring step of monitoring if a web service stored in the storage unit can be used; and
an initialization process request step that, when the monitoring step determines that the web service is not usable, asserts an initialization process request to the web service to initialize the web service for use.

2. The web service processing method for a web service providing device described in claim 1, wherein:
the initialization process request step is executed in conjunction with the startup of the web service providing device.

3. The web service processing method for a web service providing device described in claim 1, wherein:
the monitoring step determines if the web service can be used by monitoring the status of a web service container that is the web service execution environment.

4. The web service processing method for a web service providing device described in claim 1, wherein:
the monitoring step determines if the web service can be used by monitoring if the web service is loaded in a specific memory.

5. The web service processing method for a web service providing device described in claim 1, wherein:
the web service providing device is connected to one or more devices corresponding to the web services stored in the storage unit; and
the monitoring step determines if the web service can be used by monitoring if the corresponding device can be used.

6. The web service processing method for a web service providing device described in claim 1, wherein:
the list of web services stored in the storage unit is separated into web services that are to be monitored and web services that are not monitored; and
of the web services stored in the storage unit, the monitoring step monitors the web services that are to be monitored.

7. The web service processing method for a web service providing device described in claim 1, wherein:
of the web services stored in the storage unit, the monitoring step monitors web services written in a specific language.

8. The web service processing method for a web service providing device described in claim 6 or 7, wherein:
of the web services stored in the storage unit, the initialization process request step asserts an initialization process request for a web service that is not monitored by the monitoring step when a process request is received from the client device.

9. The web service processing method for a web service providing device described in claim 1, wherein:
the storage unit stores for each web service a link to a client device that can use the web service selected from among the one or more client devices; and
the monitoring step monitors the startup of each client device, and monitors whether or not the web service linked to a particular client device can be used when startup of that particular client device is detected.

10. The web service processing method for a web service providing device described in claim 9, wherein:
the storage unit stores a priority level for each web service; and
the monitoring step monitors the usability of web services linked to a desired client device according to the priority level of each web service.

11. A web service providing device that provides a web service to one or more connected client devices, comprising:
a storage unit that stores a list of web services that can be provided;
a monitoring unit that monitors whether or not the web services stored in the storage unit can be used; and
an initialization process request unit that, when the monitoring unit determines that the web service is not usable, asserts an initialization process request to the web service to initialize the web service for use.

12. The web service providing device described in claim 11, wherein:
the initialization process request unit asserts an initialization process request for the web service linked to startup of the web service providing device.

13. The web service providing device described in claim 11, wherein:
the web service providing device is connected to one or more devices corresponding to the web services stored in the storage unit; and
the monitoring unit determines whether or not the web services can be used by monitoring one or more of the state of a web service container that is the web service execution environment, whether or not the web service is loaded in a specific memory, and whether or not the corresponding device can be used.

14. The web service providing device described in claim 11, wherein:
the web service receives a command from the client device, asserts a process request to a connected device based on said command, and sends the process result to the client device.

15. The web service providing device described in claim 11, wherein:
the client device is a POS terminal, and the web service is a software module for controlling a peripheral device of the POS terminal.
